(19) United States
(12) Patent Application Publication
(10) Pub. No.: US 2007/0056610 A1
(43) Pub. Date: Mar. 15, 2007

(54) Washer and operation control method therefor

(75) Inventors: Won Keun Lee, Cheonan-city (KR); Seung Dae Yang, Cheonan-city (KR)

Correspondence Address: FITZPATRICK CELLA HARPER & SCINTO, 30 ROCKEFELLER PLAZA, NEW YORK, NY, 10112, US

(73) Assignee: Winia Mando Inc., Asan-city (KR)

(21) Appl. No.: 10/991,429

(22) Filed: Nov. 19, 2004

(30) Foreign Application Priority Data
Nov. 19, 2003 (KR) 2003-82132
Nov. 19, 2003 (KR) 2003-82133
Nov. 20, 2003 (KR) 2003-82431

(51) Int. Cl. B08B 7/04; B08B 9/20; B08B 3/00; B08B 3/12

(52) U.S. Cl. 134/25.3; 134/198; 134/184; 134/18; 134/56 R

(57) ABSTRACT

A washer and a method of controlling operation of the washer is provided. The washer includes a main body; a washing chamber which is disposed in the main body and accommodates a stuff to be washed, including a water outlet formed on the bottom surface thereof and a water feed inlet on one end of which a shower nozzle is formed; an ultrasonic oscillator generating vibration in the washing chamber; and a control unit which can control a washing process, wherein the washing chamber includes an overflow hole through which washing water can overflow from the washing chamber. The washer performs an initial washing operation and a main washing operation in combination. In the initial washing operation, stuffs to be washed such as fruits and vegetables are contained in the washing chamber and then water is supplied on the stuffs to be washed through the shower nozzle in a showering manner to then be discharged so that foreign matter stick to the stuffs can be primarily removed. In the main washing operation, water is re-supplied into the washing chamber to fill the washing chamber up, to then perform the main washing operation called an ultrasonic washing operation through the ultrasonic oscillator. During performing the main washing operation, water is additionally fed in every period of time in a manner that a certain amount of floating matter can be flown out through the overflow hole. As a result, light foreign matter floating in the water among the foreign matter detached from the stuffs to be washed is flown out together with the water, to thereby prevent floating foreign matter from sticking again to the stuffs during washing and improve a washing effect. The washer can automatically and cleanly wash stuffs such as fruits and vegetables to be washed which requires a long washing time, to thereby provide an effect of shortening the whole washing time.

### BACKGROUND OF THE INVENTION

1. Field of the Invention

The present invention relates to a washer and an operation control method therefor, and more particularly, to a washer and an operation control method therefor which can perform a main washing operation such as an ultrasonic washing operation through an ultrasonic oscillator as well as an initial washing operation employing a showering manner through shower nozzles, to thereby automatically and cleanly wash stuffs to be washed such as fruits and vegetables without consuming much washing time and then provide an effect of shortening the whole washing time.

2. Description of the Related Art

In general, dishes are washed manually by hands or in an existing dishwasher.

The dishwashers are chiefly used for washing dishes in homes or restaurants, and also used for washing vegetables or fruits sometimes, which provide conveniences in life styles.

The dishwashers can be classified into two types according to a washing method.

One is a dishwasher which adopts a nozzle spraying method which sprays water through nozzles at high pressure, and the other is an ultrasonic washer which adopts an ultrasonic washing method which removes the leftover food attached on the surface of dishes through ultrasonic waves after putting the dishes in a washing chamber in which water is filled.

Here, the washer spraying water via nozzles includes a nozzle spraying unit, a basket containing stuffs to be washed such as dishes, a dish shelf on which dishes are put, and a water outlet. The nozzle spraying type washer further includes a heating unit for drying dishes washed with high-pressure water.

Thus, the nozzle spraying type washer uses high-pressure water which is forcedly sprayed by a nozzle spraying unit in order to physically remove leftover food stick to dishes. Most of washers which are used in general homes employs the nozzle spraying washing method.

However, the existing nozzle spraying washer does not spray water uniformly on each and every portion of stuffs to be washed. As a result, some portions which are not washed occur in dishes. In particular, it takes much time and water to remove dried leftover food attached on dishes.

Further, since water is sprayed at high pressure, vegetables and fruits which have thin and soft skins can be damaged by high-pressure water. Accordingly, the existing dishwasher is not appropriate for washing fruits and vegetables.

In addition, the existing nozzle spraying washer cannot remove fat and starch perfectly even with a washing detergent.

Accordingly, an ultrasonic washer which has an excellent washing effect in comparison with the existing nozzle spraying washer, and performs a sterilization function, is being partly used.

The ultrasonic washer adopts a washing method which removes a leftover food stick on stuffs to be washed by a mutual reaction of a cavity phenomenon and a negative pressure effect due to a spraying pressure. Since dishes are put in a washing chamber of the ultrasonic washer together with water, and then ultrasonic waves are generated to vibrate the water into which the dishes are soaked in order to remove foreign matter stained on the surface of the dishes, a detergent is not needed and less water is consumed than the nozzle spraying washer.

Thus, the ultrasonic washer gradually replaces the nozzle spraying washer which sprays water, uses a detergent, and then re-sprays water to rinse and finally applies hot wind to dry dishes.

However, in the case of the existing ultrasonic washer, floating matter generated after washing may stick again to stuffs to be washed during discharging water, and thus re-stain the surface of the stuffs to thereby prevent the stuffs from being washed perfectly.

These defects are due to a control method of supplying and discharging water to and from the existing ultrasonic washer.

That is, when the existing ultrasonic washer starts to run, water is supplied into a water chamber from an external water pipe through a water supply valve, and the water chamber is filled with the supplied water while the water level gradually goes up from the bottom of the water chamber. According to change of the water level, air compression in an air chamber is varied and then an air pressure is transferred to a pressure sensor to thus detect the water level.

An amount of the supplied water is detected through the above-described process, and thus if the water level reaches a full-water level during an initial water supply, the water supply valve is closed to then stop the water supply and activate an ultrasonic oscillator.

When the ultrasonic oscillator operates continuously and thus a total washing time reaches a predetermined washing time, the ultrasonic oscillator stops to run and then the washer finishes the washing operation and starts to discharge the water from the water chamber.

However, since the conventional control method for a washer continuously performs a washing operation with the water supplied up to the initial full-water level, the floating matter occurring in the process of washing sticks again to the stuffs to be washed during discharging the water, which pollutes the surface of the stuffs again. In particular, in the case that fruits and vegetables are washed, since the floating matter such as the remainder of the agricultural chemical and the foreign matter may stick again to the surface of the fruits and vegetables during discharging the water, the fruits and vegetables should be washed again with the clean water.

### SUMMARY OF THE INVENTION

To solve the above problems, it is an object of the present invention to provide a washer and a control method therefor, which enables an initial washing operation using shower nozzles and a main washing operation using an overflow hole provided in a washing chamber and an ultrasonic oscillator, to thus automatically and cleanly wash fruits and vegetables to be washed which requires a long washing time.

That is, it is the object of the present invention to provide a washer and a control method therefor, which performs an initial washing operation in which water is sprayed on the stuffs to be washed through shower nozzles in a showering manner to remove foreign matter sticking to the stuffs to then be discharged so that foreign matter sticking to the stuffs can be primarily removed together with the water through a water outlet, and then a main washing operation in which water is filled in a washing chamber and foreign matter sticking to the stuffs is ultrasonically washed by an ultrasonic oscillator, and performs an additional water supply at the full-water level so that foreign matter floating on the water can be discharged through an overflow hole, to thus prevent the foreign matter from sticking again to the stuffs.

It is another object of the present invention to provide a washer and a control method therefor, in which a water discharge tube connected with a water outlet provided in a water washing chamber is formed in the form of winding the outer surface of the ultrasonic oscillator, to thereby cool heat generated from the ultrasonic oscillator and enhance durability of the ultrasonic oscillator.

It is still another object of the present invention to provide a washer and a control method therefor, further including a floating prevention unit which prevents floating matter from sticking again to stuffs to be washed in a washing chamber, to thereby further enhance a washing effect.

It is yet another object of the present invention to provide a washer and a control method therefor, which includes a sensor unit detecting a water level and a control unit in order to perform an effective control so that stuffs to be washed can be automatically washed through an ultrasonic oscillator when the water level reaches a predetermined supply water level and discharge water level, to thereby shorten the whole running time including a washing time.

To accomplish the above object of the present invention, there is provided a washer comprising: a main body forming an external case; a washing chamber which is disposed in the main body and accommodates a stuff to be washed, including a water outlet formed on the bottom surface thereof and a water feed inlet on one end of which a shower nozzle spraying water on the surface of the stuff in a showering manner is formed; an ultrasonic oscillator installed in one end of the washing chamber and generating vibration through ultrasonic oscillation in the washing chamber full of the washing water; and a control unit installed in one end of the main body, which controls a washing process of the stuff.

Here, the washer according to the present invention comprises an overflow hole formed in the upper end of the washing chamber, and through which washing water can overflow from the washing chamber.

In addition, it is preferable that a sensor unit detecting a water level in the washing chamber is installed, and that the sensor unit comprises a full-water level sensor formed in the upper end of one side of the washing chamber and an empty-water level sensor formed in the lower end of one end of the washing chamber.

Preferably, a door is installed in one end of the main body so that an opening in the washing chamber can be closed and opened.

In particular, a water discharge tube connected with the water outlet winds up around the ultrasonic oscillator so that the water discharged through the water outlet cools the ultrasonic oscillator, and extends outwards.

It is also preferable that the washer according to the present invention further comprises a floating prevention unit which prevents stuffs to be washed contained in the washing chamber from floating on the water.

Here, the floating prevention unit comprises a door installed on one end of the main body so that an opening in the washing chamber is closed and opened, and a pressing plate installed on the bottom of the door, for pressing the stuffs to be washed contained in the washing chamber. Otherwise, the floating prevention unit is a washing basket which comprises a basket whose upper portion is opened, containing stuffs to be washed, and a cover which can cover the opening of the basket.

It is also preferable that the water outlet and water supply inlet are automatically closed and opened by solenoid valves which are controlled by the controller.

It is also preferable that the overflow hole is installed in opposition to the water supply inlet.

There is also provided a control method for a washer washing stuffs to be washed such as fruits and vegetables, the control method comprising the steps of: (a) selecting the kind of the stuffs to be washed and starting a washing operation; (b) performing an initial washing operation; (c) performing a main washing operation, and additionally supplying water in every period of time during performing the main washing operation so that a certain amount of the water is discharged through an overflow hole; and (d) performing a final washing operation of rinsing the stuffs when the main washing operation is finished.

There is still also provided a control method for a washer washing stuffs to be washed such as fruits and vegetables, the control method comprising the steps of: (a) selecting the kind of the stuffs to be washed and starting a washing operation; (b) performing an initial washing operation; (c) performing a main washing operation which supplies water until a current water level reaches a full-water level in the washing chamber detected by a full-water level sensor in the washer; (d) additionally supplying water in every period of time during performing the main washing operation so that a certain amount of the water is discharged through an overflow hole; (e) continuously performing a washing operation until a current water level reaches an empty-water level detected by an empty-water level sensor in the washer, during discharging the water from the washing chamber; and (f) performing a final washing operation of rinsing the stuffs when the main washing operation is finished.

### BRIEF DESCRIPTION OF THE DRAWINGS

The above and other objects and advantages of the present invention will become more apparent by describing the preferred embodiments thereof in detail with reference to the accompanying drawings in which:

FIG. 1 is a perspective view schematically showing a washer according to a preferred embodiment of the present invention;

FIG. 2 is an exploded perspective view schematically showing a washer according to the present invention;

FIG. 3 is a cross-sectional view showing that a single water level sensor is included in a sensor unit installed in a washer, as a first embodiment of the present invention;

FIG. 4 is a plan view showing a disposition layout of a water outlet tube and an ultrasonic oscillator in a washer according to the present invention;

FIG. 5 is a cross-sectional view showing that a plurality of water level sensors are included in a sensor unit installed in a washer, as a second embodiment of the present invention;

FIG. 6 is a cross-sectional view showing a pressing plate as a first embodiment of a floating prevention unit added in a washer according to the present invention;

FIG. 7 is a cross-sectional view showing a state of use of the pressing plate as the floating prevention unit shown in FIG. 6;

FIG. 8 is a perspective view showing a washing basket as a second embodiment of a floating prevention unit added in a washer according to the present invention;

FIG. 9 is a cross-sectional view showing a state of use of the washing basket as the floating prevention unit shown in FIG. 8;

FIG. 10 is a block diagram showing correlation between some elements applied in the washer according to the first embodiment of the present invention;

FIG. 11 is a flowchart view for explaining an operation control method of the washer according to the first embodiment of the present invention;

FIG. 12 is a cross-sectional view showing an initial washing operation of the washer according to the first embodiment of the present invention;

FIG. 13 is a cross-sectional view showing a main washing operation of the washer according to the first embodiment of the present invention;

FIG. 14 is a cross-sectional view showing an overflow state of water through an additional water supply during the main washing operation of the washer according to the first embodiment of the present invention;

FIG. 15 is a block diagram showing correlation between some elements applied in the washer according to the second embodiment of the present invention;

FIG. 16 is a flowchart view for explaining an operation control method of the washer according to the second embodiment of the present invention;

FIG. 17 is a cross-sectional view showing an initial washing operation of the washer according to the second embodiment of the present invention;

FIG. 18 is a cross-sectional view showing a main washing operation of the washer according to the second embodiment of the present invention;

FIG. 19 is a cross-sectional view showing a main washing operation at a full-water level of the washer according to the second embodiment of the present invention; and

FIG. 20 is a cross-sectional view showing an overflow state of water through an additional water supply during the main washing operation of the washer according to the second embodiment of the present invention.

### DETAILED DESCRIPTION OF THE INVENTION

A washer for washing food stuffs according to respective preferred embodiments of the present invention will be described with reference to the accompanying drawings. Hereinbelow, the same reference numerals are assigned with respect to the same components in each embodiment.

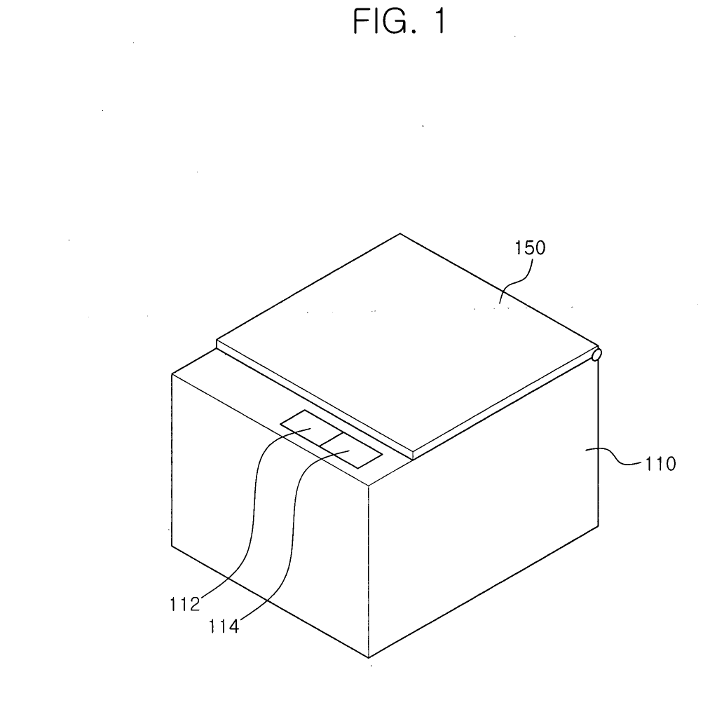

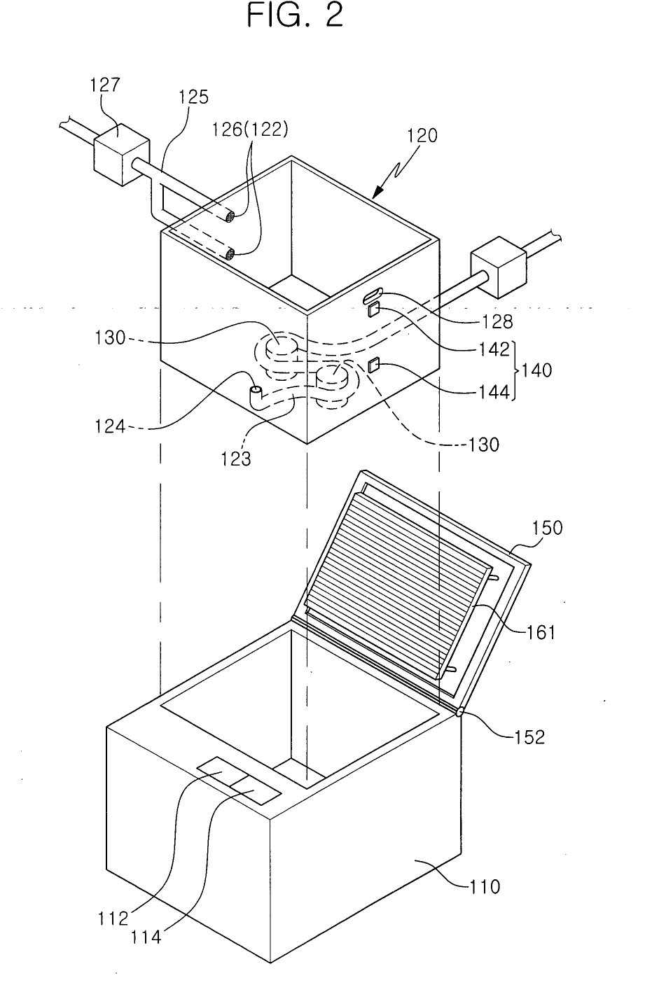

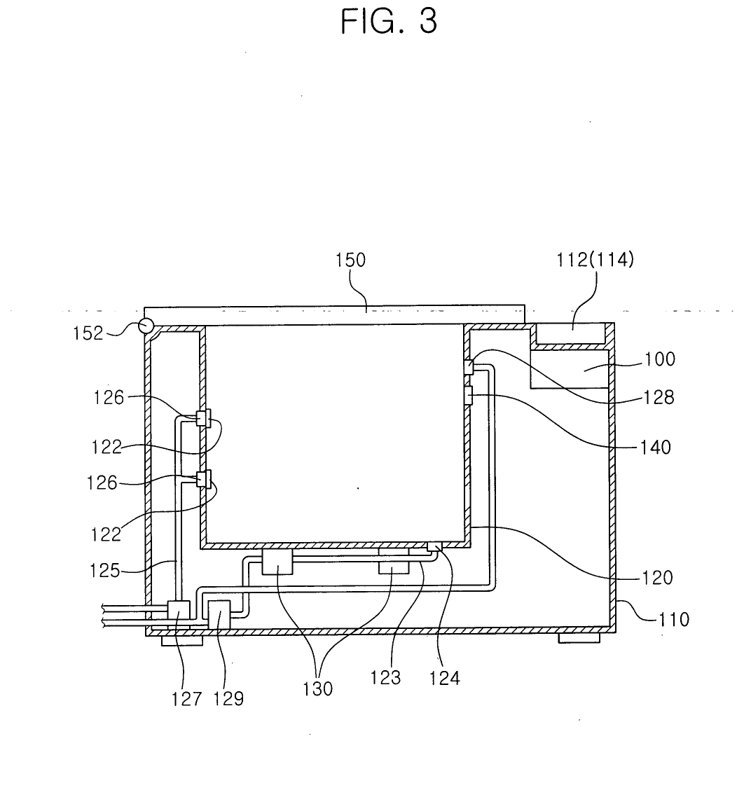

FIG. 1 is a perspective view schematically showing a washer according to a preferred embodiment of the present invention. FIG. 2 is an exploded perspective view schematically showing a washer according to the present invention. FIG. 3 is a cross-sectional view showing that a single water level sensor is included in a sensor unit installed in a washer, as a first embodiment of the present invention. As shown in FIGS. 1 to 3, a washer to which the present invention is applied includes the substantially same structure as those of a conventional ultrasonic washer. The washer includes: a main body 110 forming an external appearance; a washing chamber 120 which accommodates and washes stuffs to be washed; an ultrasonic oscillator 130 generating vibration in the washing chamber 120 so that the stuffs accommodated in the washing chamber 120 can be ultrasonically washed by the generated ultrasonic waves; and a control unit 100 which can control a washing process.

Here, the washer according to the present invention is a showering-type washer having shower nozzles 122, which takes the merits of the conventional ultrasonic washer and improves the problems of the conventional nozzle spraying washer.

That is, the washer according to the present invention enables an initial washing operation through water sprayed in a showering manner using shower nozzles 122 and a main washing operation through ultrasonic washing via an ultrasonic oscillator 130.

Thus, the washer according to the present invention combines the initial washing operation through the shower nozzles 122 with the main washing operation through the ultrasonic oscillator 130, to thereby maximize the washing effect.

In particular, the present invention provides a washer having additional components for enhancing functions of the washer such as an increase in the washing effect and shortening of the washing time.

That is, as shown in FIGS. 1 and 2, the washer according to a preferred embodiment of the present invention basically includes the main body 110, the washing chamber 120, the ultrasonic oscillator 130, and the control unit 100, and additionally includes a sensor unit 140, a door 150, and a floating prevention unit 160 all of which will be described later and are provided to perform a variety of functions for enhancing functions of the washer.

Hereinbelow, the structure of the washer according to the preferred embodiment of the present invention will be described in more detail with reference to the accompanying drawings.

As shown in FIGS. 1 to 3, the main body 110 is in the form of a case having a noise cancellation structure and a heat radiation structure. The washer includes a control panel 112 which enables a user to select the kind of a stuff to be washed and input a washing command in order to control the washer and a display 114 which displays a control status of the washer, on the upper portion of the front panel of the washer. Here, the main body 110 has a noise cancellation structure and a heat radiation structure together with the structural feature of the case, and thus performs a function of preventing noise and heat which are generated therein from being leaked externally. The control unit 100 having a controller such as a microcomputer is installed in the control panel 112 provided in the main body 10. Also, it is preferable that the display 114 connected with the control unit 100 includes a buzzer (not shown) outputting a signal sound when washing is finished. The washing chamber 120 is disposed in the inner portion of the main body 110, and is formed of an inner case forming an accommodation space containing stuffs to be washed.

In particular, as the essential components of the washer according to the present invention, water supply inlets 126 on each one end of which a shower nozzle 122 which can spray water in a showering manner is formed on one side of the washing chamber 120, and an overflow hole 128 which enables water to overflow is formed on the upper end of one side of the washing chamber 120. Here, the overflow hole 128 is a water outlet hole which discharges water externally from the washing chamber 120 when the water level in the washing chamber 120 is above a full-water level. It is preferable that the overflow hole 128 is formed on the surface opposing the water supply inlets 126 in the washing chamber 120.

In addition, the shower nozzles 122 provided in the water supply inlets 126 play a role of spraying water on stuffs to be washed in an initial washing step and initially washing foreign matter attached on the stuffs. It is preferable that at least one water supply inlet 126 on one end of which a shower nozzle 122 is formed is disposed on the inner wall of the washing chamber 120. The reason why at least one water supply inlet 126 on one end of which a shower nozzle 122 is formed is provided on all the surfaces of the washing chamber 120, or up and down on the inner wall of one side thereof, is to solve a problem that a water spraying nozzle in the conventional washer employing a conventional nozzle spraying method does not uniformly spray water on every nook and corner of stuffs to be washed and thus causes portions which are not washed yet to be left. Thus, as a result, the washer according to the present invention sprays water uniformly all over the full areas of the stuffs to be washed through the shower nozzles 122, to thus enhance an initial washing effect greatly.

Here, the shower nozzles 122 have the same structure as those of a conventional shower unit which sprays water, and have a relatively low spraying pressure and a greatly extended spraying range, in comparison with the conventional spraying nozzles which are used in the conventional nozzle spraying washer. Thus, the washer according to the present invention can wash even fruits and vegetables whose skins are thin or not firm, which cannot be washed in a nozzle spraying washer which sprays high-pressure water. In particular, the washer according to the present invention can be very usefully used in order to wash fruits such as strawberry and grape and vegetables such as lattice which can be easily damaged when high-pressure water is sprayed and which requires a long washing time during washing.

Here, the water supply inlet 126 is connected to a water supply tube 125 having a water supply valve 127 which regulates a supply of water. The water supply valve 127 is a solenoid valve which is controlled by the control unit 100 so as to be automatically closed and opened. A water outlet 124 for discharging water is provided in the washing chamber 120 together with the water supply inlet 126 which supplies water. Here, it is preferable that the water outlet 124 is typically formed on the bottom of the washing chamber 120, and is connected to a water discharge tube 123 on the bottom of the washing chamber 120 in order to smoothly discharge water out of the washer. Of course, a water discharge valve 129 which can close and open water to be discharged is provided on the water discharge tube 123. Like the water supply valve 127 provided in the water supply tube 125, the water discharge valve 129 is a solenoid valve which is automatically closed and opened under the control of the control unit 100.

The ultrasonic oscillator 130 which is an essential component of the washer according to the present invention is a well-known device which can oscillate ultrasonic waves via an ultrasonic oscillating element. It is preferable that the ultrasonic oscillator 130 is installed on the bottom of the washing chamber 120. Thus, the ultrasonic oscillator 130 generates vibration such as ultrasonic oscillation into the washing chamber 120, and thus plays a role of removing and washing the leftover from stuffs to be washed by a mutual reaction between a cavity phenomenon and a negative pressure effect due to a spraying pressure. In particular, the ultrasonic oscillator 130 in the washer according to the present invention has a function of performing a main washing operation such as an ultrasonic washing operation through ultrasonic oscillation after performing an initial washing operation for stuffs to be washed through the shower nozzles 122. Here, the ultrasonic oscillator 130 may include a number of ultrasonic oscillating elements (not shown) on the bottom of the washing chamber 120 according to a washing capacity.

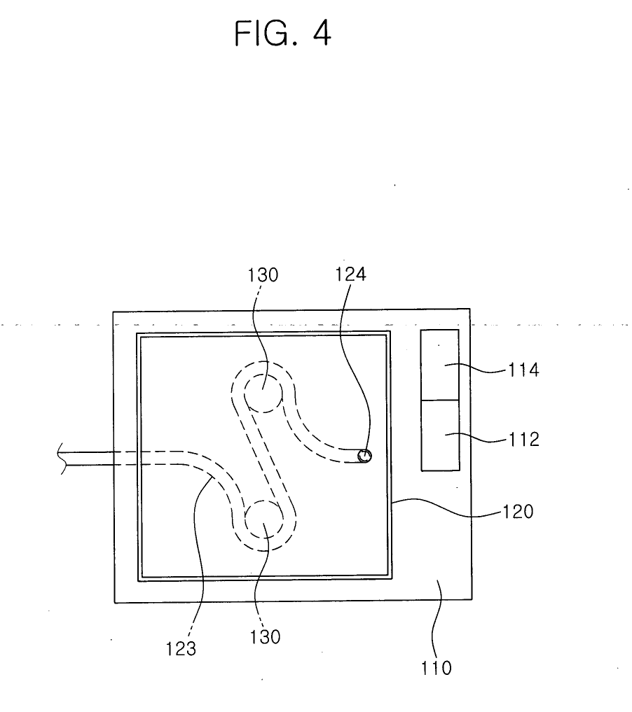

FIG. 4 is a plan view showing a disposition layout of a water outlet tube and an ultrasonic oscillator in a washer according to the present invention.

Meanwhile, as shown in FIGS. 2 and 4, the water discharge tube 123 which is connected with the water outlet 124 formed on the bottom of the washing chamber 120 is extended outwards from the main body 110 at the state where it is wound round the ultrasonic oscillator 130 installed on the bottom of the washing chamber 120. Since the water discharge tube 123 is wound round the periphery of the ultrasonic oscillator 130 in a tube laying structure, water is discharged via the ultrasonic oscillator 130 along the water discharge tube 123 in the process of discharging water after washing stuffs to be washed. Accordingly, the discharged water can cool heat of the ultrasonic oscillator 130 whose temperature rises up due to ultrasonic oscillation. As a result, the structure of laying the water discharge tube 123 provides an effect of greatly enhancing durability of the ultrasonic oscillator 130.

The sensor unit 140 is formed on one side of the washing chamber 120, and detects a level of water filled in the washing chamber 120. According to the number of water level sensors installed in the sensor unit 140, an operation control method of the washer can vary.

That is, as a first embodiment of the washer shown in FIG. 3, only one water level sensor is provided in the sensor unit 140, to thereby detect an amount of water supplied to the washing chamber 120 according to an amount of stuffs to be washed, and control an amount of water supply via the water supply valve 127 composed of a solenoid valve.

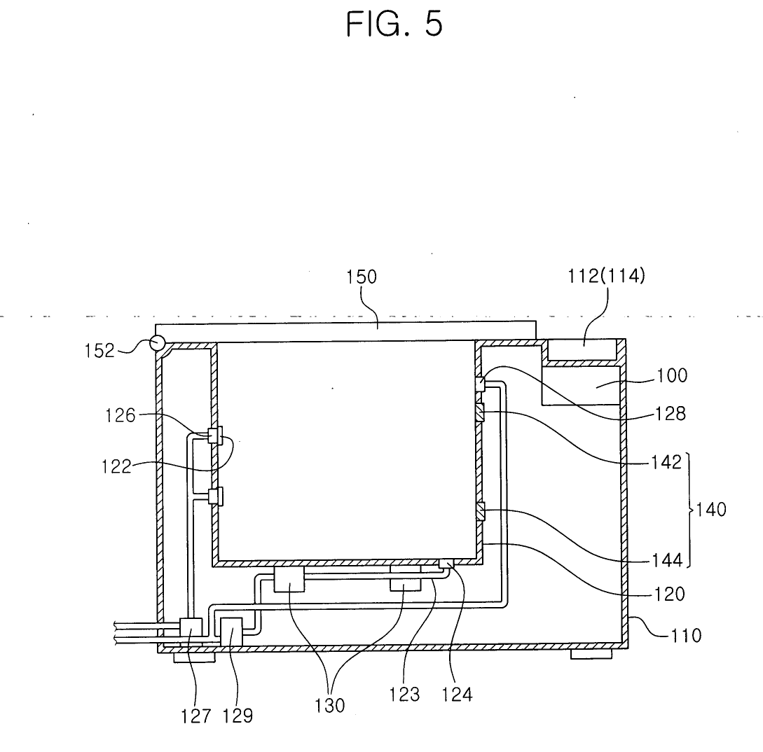

FIG. 5 is a cross-sectional view showing that a plurality of water level sensors are included in a sensor unit installed in a washer, as a second embodiment of the present invention.

Meanwhile, in a washer according to a second embodiment of the present invention as shown in FIG. 5, a sensor unit 140 includes a plurality of water level sensors. That is, the sensor unit 140 according to the second embodiment of the present invention includes a full-water level sensor 142 formed in the upper end of one side of a washing chamber 120 and an empty-water level sensor 144 formed in the central-lower end of one side of the washing chamber 120. In the case that the sensor unit 140 includes the full-water level sensor 142 and the empty-water level sensor 144 as described above, the washer can be efficiently controlled during the overall washing process, to thereby enhance a washing effect and shorten a washing time. To dilate, in the case that an operation control is performed using the plurality of water level sensors, it is determined whether or not an ultrasonic oscillator 130 should be activated, after it has been determined whether or not water has passed through the empty-water level sensor 144, in the process of supplying water into the washing chamber 120 or discharging water after performing a washing operation, to thereby provide a reference point in time to determine a washing start point in time. Accordingly, the plurality of water level sensors enable a more effective washing control.

Here, a difference of a detailed operation control method and a functional effect according to the number of water level sensors in the sensor unit 140 will be described later.

Meanwhile, it is preferable that the washer according to the present invention includes a door 150 which can close and open an opening of the washing chamber 120. That is, one end of the door 150 is fixed to one side of the main body 110 so as to close and open an accommodation space in the washing chamber 120. Here, it is preferable that the door 150 is installed using a hinge 152 which is a well-known component, and thus can be rotatably closed and opened around the hinge 152. In particular, the door 150 plays a role of interrupting water splash or vibration noise from spreading in the process of washing stuffs to be washed.

In addition, the washer according to the present invention includes a floating prevention unit 160 which prevents stuffs to be washed contained in the washing chamber 120 from floating up to the water level. Here, the floating prevention unit 160 prevents light stuffs to be washed from floating on the water since a washing effect due to vibration of the ultrasonic oscillator 130 is lowered in the case that the light stuffs do not sink into the water in the washing chamber 120 but float up to the water level. Thus, any shape of the structure which can prevent stuffs to be washed from floating up to the water level in the washing chamber 120 can be applied to the floating prevention unit 160.

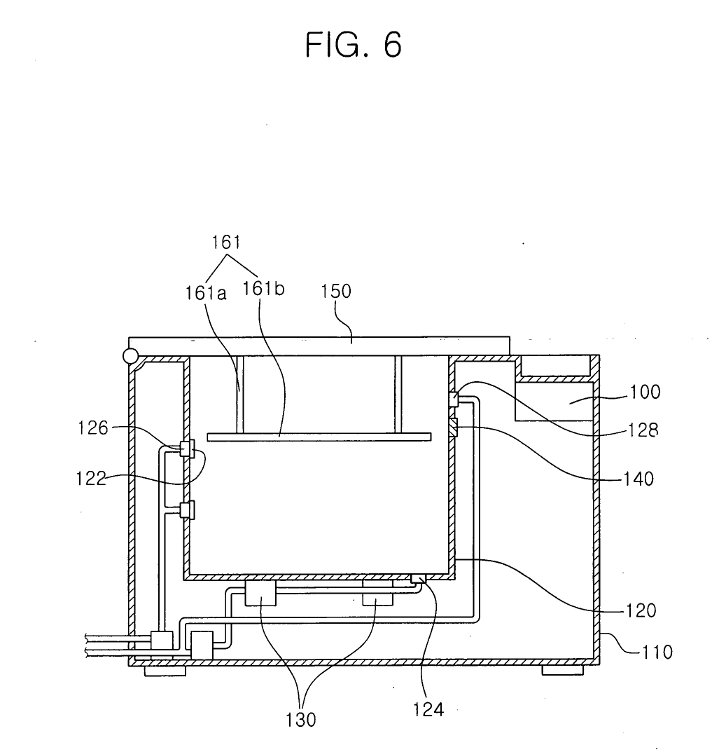

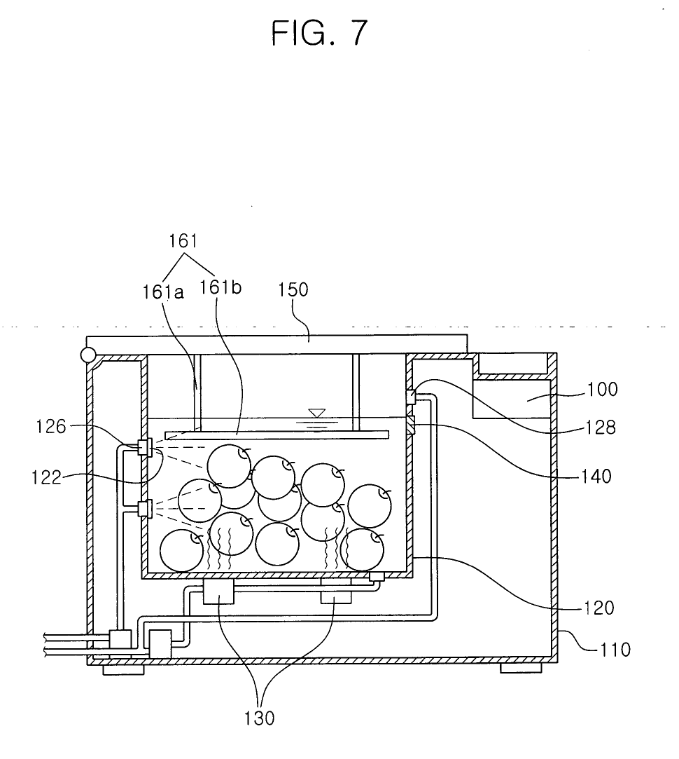

FIG. 6 is a cross-sectional view showing a pressing plate as a first embodiment of a floating prevention unit added in a washer according to the present invention, and FIG. 7 is a cross-sectional view showing a state of use of the pressing plate as the floating prevention unit shown in FIG. 6.

In the washers according to preferred embodiments of the present invention, there are provided two kinds of the floating prevention units 160.

That is, as shown in FIGS. 6 and 7, the floating prevention unit 160 according to a first embodiment of the present invention has a pressing plate 161 which protrudes from the bottom of the door 150.

Here, the pressing plate 161 includes support rods 161a which are supported and fixed on the bottom of the door 150, and a flat plate 161b which is attached on each leading end of the support rods 161a to thereby press stuffs to be washed. The pressing plate 161 is fabricated to have such a sufficient length that the flat plate 161b in the pressing plate 161 can be located below the water level having the full-water level in the washing chamber 120, in the case that the door 150 on which the pressing plate 161 is attached is closed. Here, when the door 150 is fabricated, it is possible that the pressing plate 161 is integrally mounted on the bottom of the door 150. However, more preferably, the pressing plate 161 may have the structure that it can be selectively and detachably mounted on the bottom of the door 150 according to the user's necessity during use of the washer. That is, the pressing plate 161 can be detachably mounted on the bottom of the door 150 through an assembly hole (not shown) provided on the bottom of the door 150 using a variety of well-known conventional engagement methods such as a fitting connection or screw connection, of which the detailed description thereof will be omitted.

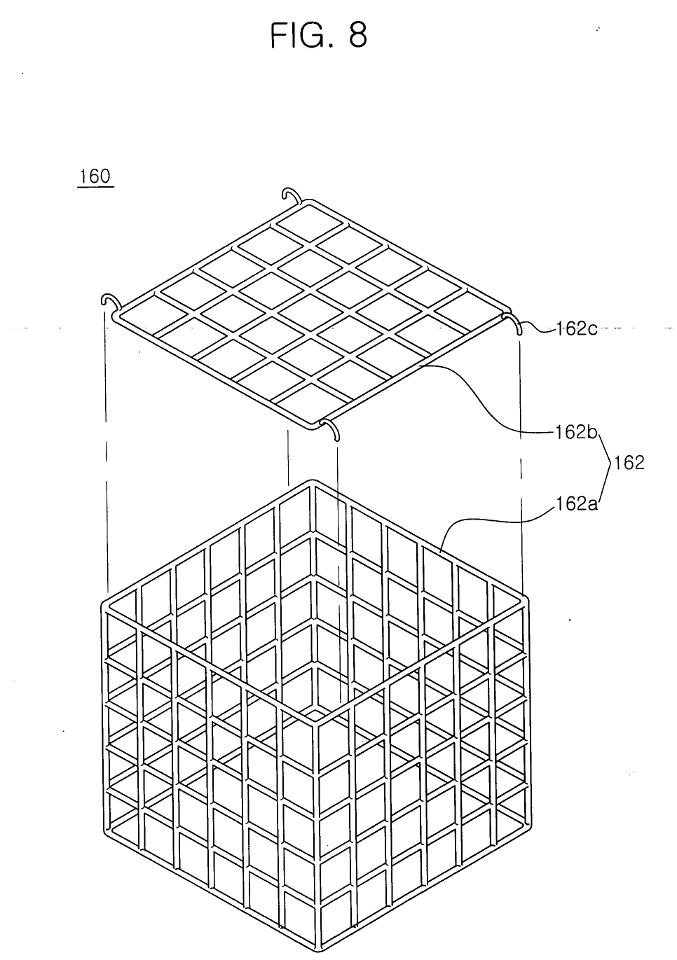

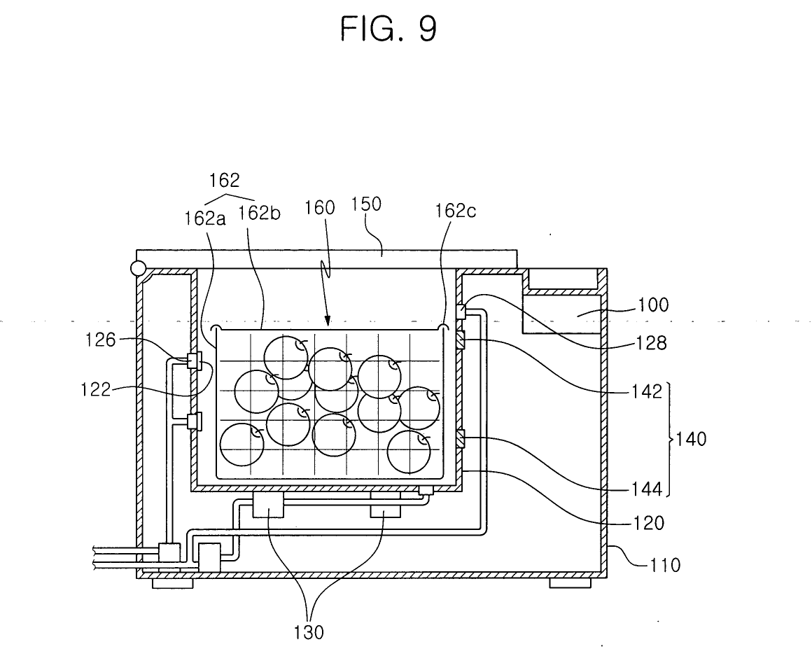

FIG. 8 is a perspective view showing a washing basket as a second embodiment of a floating prevention unit added in a washer according to the present invention, and FIG. 9 is a cross-sectional view showing a state of use of the washing basket as the floating prevention unit shown in FIG. 8.

As shown in FIGS. 8 and 9, a floating prevention unit 160 which is applied to a washer according to a second embodiment of the present invention has a structure of a washing basket 162 including a basket 162a filling stuffs to be washed and a cover 162b covering the opening of the basket 162a. That is, the washing basket 162 includes the basket 162a which is opened upwards, for filling stuffs such as fruits and vegetables, and the cover 162b having locking units 162c corresponding to the respective upper corners of the basket 162a so as to cover the opening of the basket 162a. Accordingly, the washing basket 162 can be soaked in the water in the washing chamber 120 at the state where stuffs to be washed are filled in the washing basket 162. In other words, the washing basket 162 is caught by the locking units 162c of the cover 162b at the state of having filled stuffs such as fruits and vegetables in the washing basket 162a. Accordingly, the stuffs to be washed can be prevented from being released out from the basket 162a which is covered by the cover 162b, and thus the stuffs to be washed can be effectively washed by vibration due to ultrasonic oscillation of the ultrasonic oscillator 130 in the water since the washing basket 162 is soaked in the water.

Here, it is preferable that the basket 162a and the cover 162b which form the washing basket 162 have an iron net structure. This is to prevent a washing effect from being lowered since vibration generated from the ultrasonic oscillator 130 which is installed at the lower portion of the washing chamber 120 passes through the washing basket 162 made of an iron net and directly contacts the stuffs to be washed at the time of supplying water via the shower nozzles 122 formed at the side of the washing chamber 120.

Respective embodiments of the operation control methods for the washer having the above-described structure will be described below.

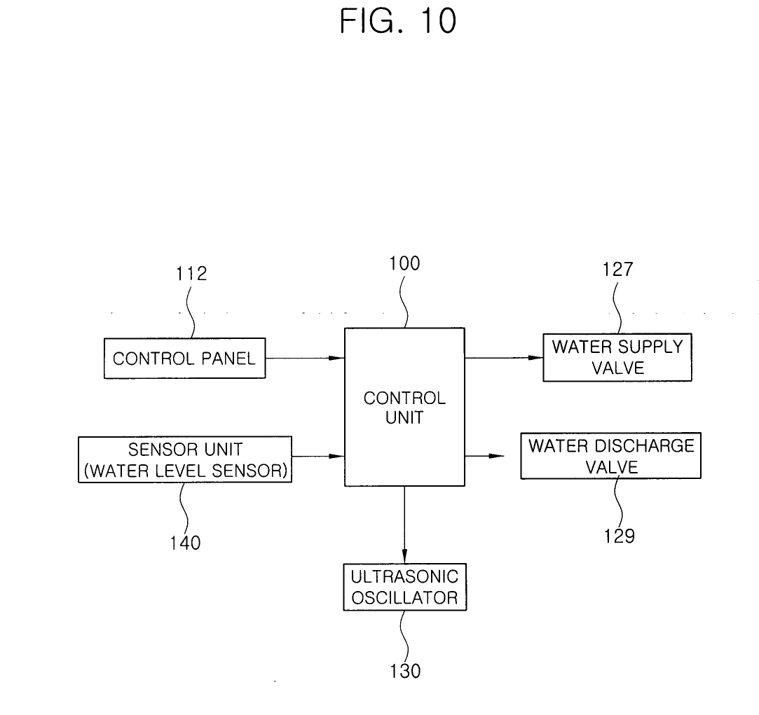

A schematic block diagram, a control flow chart view and a view showing a use status for a washer are illustrated in FIGS. 10 to 14, in order to explain an operation control method of the washer having a single water level sensor according to the first embodiment of the present invention.

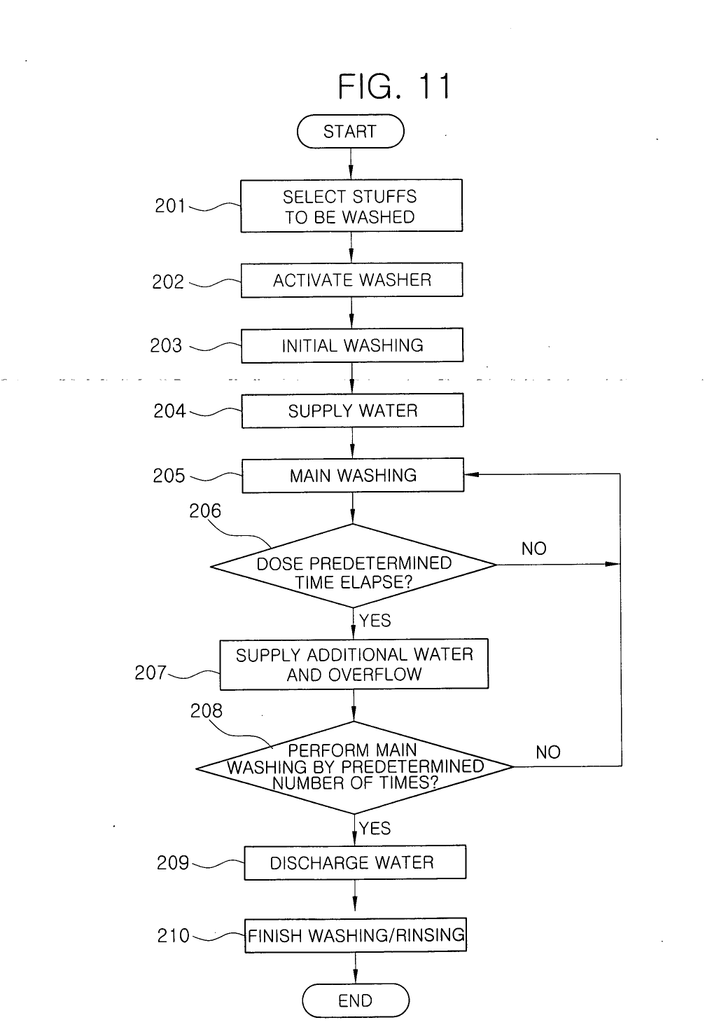

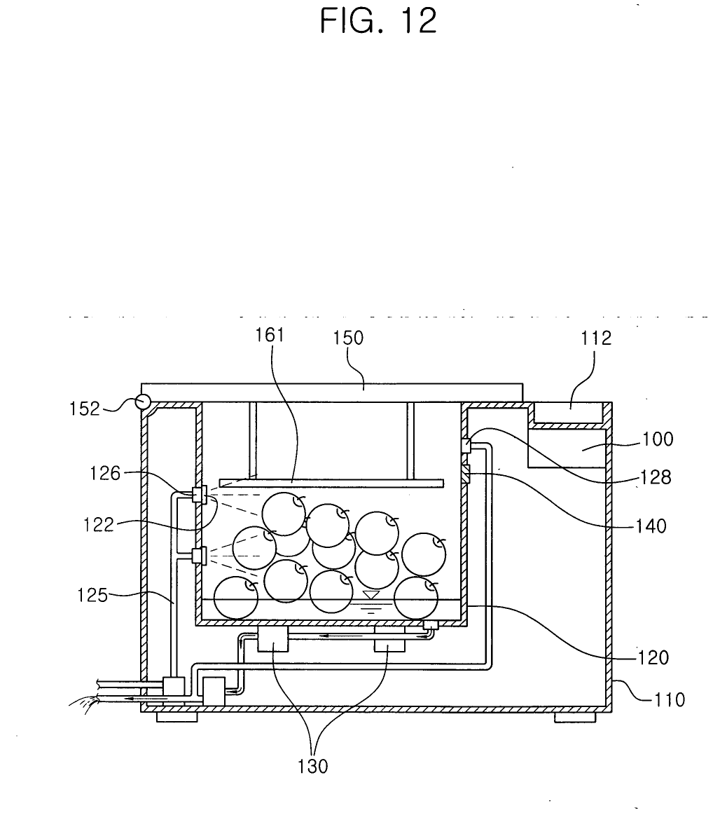

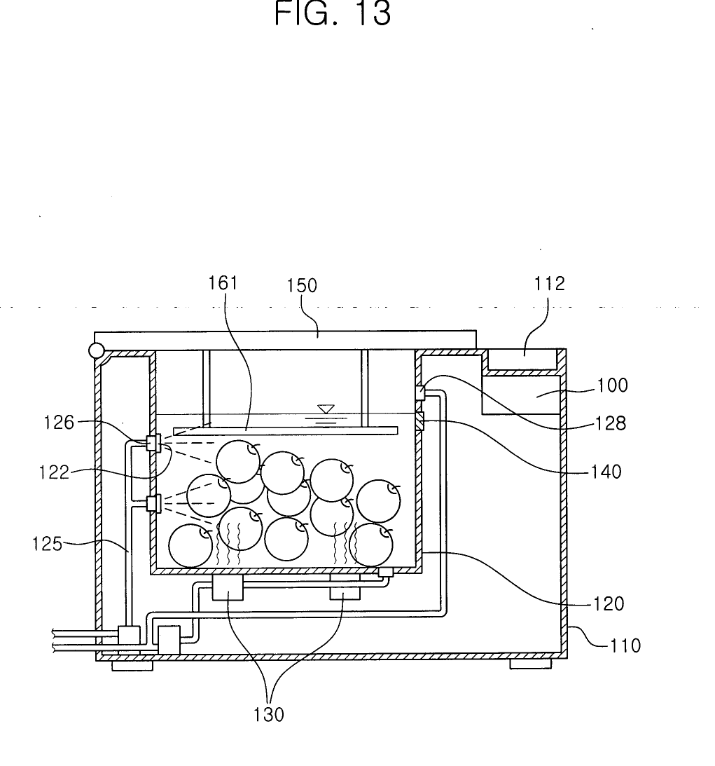

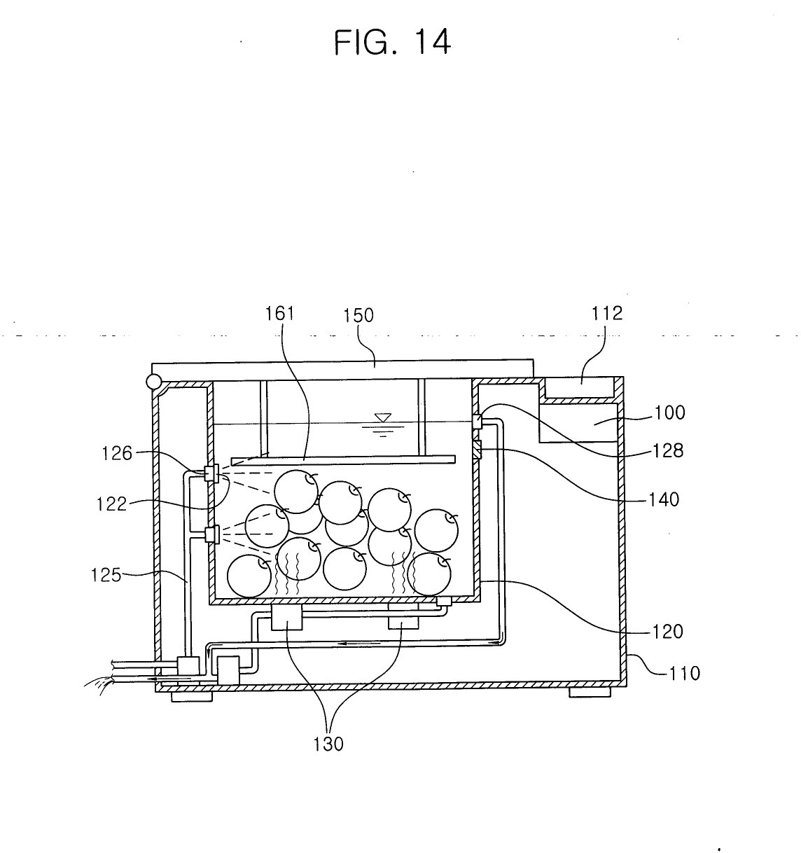

FIG. 10 is a block diagram showing correlation between some elements applied in the washer according to the first embodiment of the present invention. FIG 11 is a flowchart view for explaining an operation control method of the washer according to the first embodiment of the present invention. FIG. 12 is a cross-sectional view showing an initial washing operation of the washer according to the first embodiment of the present invention. FIG. 13 is a cross-sectional view showing a main washing operation of the washer according to the first embodiment of the present invention. FIG. 14 is a cross-sectional view showing an overflow state of water through an additional water supply during the main washing operation of the washer according to the first embodiment of the present invention.

As illustrated, when a user washes fruits and vegetables in a washer, he or she puts the stuffs in a washing chamber 120 which is installed in the inside of the main body 110, and then closes a door 150 in order to intercept water splash or vibration noise. Then, the user selectively inputs the kind of stuffs to be washed, a water level, intensity of water supplied, and a washing time through manipulation of keys formed in the front surface of the main body 10 (step 201).

For example, a washing time in the washer is adjusted according to the kind of the stuffs to be washed, that is, it takes one minute in the case of fruits such as apples or pears whose surfaces are slippery, two minutes in the case of fruits such as strawberries or grapes in which agricultural chemicals or foreign matters remain on the surfaces of the fruits, three minutes in the case of vegetables, and ten minutes in the case of dishes. In addition, intensity of supplied water can be adjusted into three steps such as weak, medium and strong, and level of supplied water can be adjusted properly into three steps such as high, medium and low according to height of stuffs to be washed.

When information has been input according to the kinds of stuffs to be washed as described above, the user manipulates keys on the control panel 112 to operate the washer (step 202).

Then, the control unit 100 which receives key inputs controls the water supply valve 127 and the water discharge valve 129 so that a water discharge operation can be performed simultaneously with a water supply operation, to thereby perform an initial washing operation of fruits or vegetables (step 203)

In other words, in the initial washing step, the control unit 100 controls the water supply valve 127 to be opened to supply the washing chamber 120 with a proper amount of water. Thus, when the water supply tube 125 is opened according to operation of the solenoid valve which is the water supply valve 127 installed on the water supply tube 125 at the side of the washing chamber 120, water is sprayed into the washing chamber 120 via the shower nozzles 122 formed on the end of each water supply inlets 126.

Here, as shown in FIG. 12, water is sprayed via the shower nozzles 122 in a showering manner. That is, water of a certain water pressure is poured on stuffs to be washed for a certain time, to thereby perform an initial washing operation which washes foreign matter sticking to the external surfaces of the stuffs. The control unit 100 controls the water discharge valve 129 to be opened as described above when the initial washing operation is performed, to thus discharge the foreign matters detached from the stuffs together with water via the water outlet 124 and the water discharge tube 123.

Then, as shown in FIG. 13, the control unit 100 controls the washing chamber 120 to be filled with water for a main washing operation (step 204). That is, the control unit 100 controls the water discharge valve 129 to close the water discharge tube 123, so that water supplied to the washing chamber 120 is not discharged therefrom but stored therein. The control unit 100 judges whether or not height of water detected by the water level sensor 140 reaches a predetermined water level, that is, a full-water level. The control unit 100 judges that the water level is the full-water level and then recognizes that water in the washing chamber 120 is a proper amount of water, to thus close the water supply valve 127.

After water has been supplied into the washing chamber 120, the control unit 100 controls the ultrasonic oscillator 130 to operate for a main washing operation via ultrasonic oscillation (step 205). Accordingly, washing and sterilization is performed by a cavity phenomenon and a negative pressure effect due to the ultrasonic waves generated by the ultrasonic oscillator 130.

As shown in FIG. 14, the control unit 100 checks whether a certain amount of time elapses during performing the main washing operation of step 205 (step 206). According to the result of checking in the step 206, the control unit 100 additionally supplies water every certain period of time so as to make water flow out via the overflow hole 128 (step 207). Accordingly, floating light foreign matter detached from the stuffs can be discharged out together with water during performing washing. Here, since the water supply inlet 126 and the overflow hole 128 are installed opposingly to each other, a flow-out or discharge operation of the floating matter can be easily performed.

As described above, the flow-out or discharge operation of the floating matter through the additional water supply during the main washing operation prevents at maximum the floating matter from being again attached to the stuffs to be washed during discharging water after completion of the washing operation.

The control unit 100 checks whether or not the main washing operation is performed by a predetermined number of times according to the kind of the stuffs to be washed (step 208). If it is determined that the control unit 100 has not performed the main washing by the predetermined number of times according to the result of checking in step 208, the washer repeatedly performs the steps 205 through 208. If it is determined that the control unit 100 has performed the main washing by the predetermined number of times according to the result of checking in step 208, the washer controls the water discharge valve 129 through the control unit 100 to open the water supply tube 123 and discharge the water via the water outlet 124 outwards (step 209). Then, a finish washing operation is performed through rinsing after completion of the main washing operation, to thereby have the remaining floating matter washed out again (step 210).

In particular, it is preferable that the control unit 100 controls a buzzer (not shown) to ring to output the whole washing operation finish signal sound to inform a user of completion of the whole washing operation.

Meanwhile, the sensor unit 140 according to the second embodiment of the present invention includes a full-water level sensor 142 and an empty-water level sensor 144, in order to enable an effective control in controlling a washing process, to thereby enhance a washing effect and shorten a washing time.

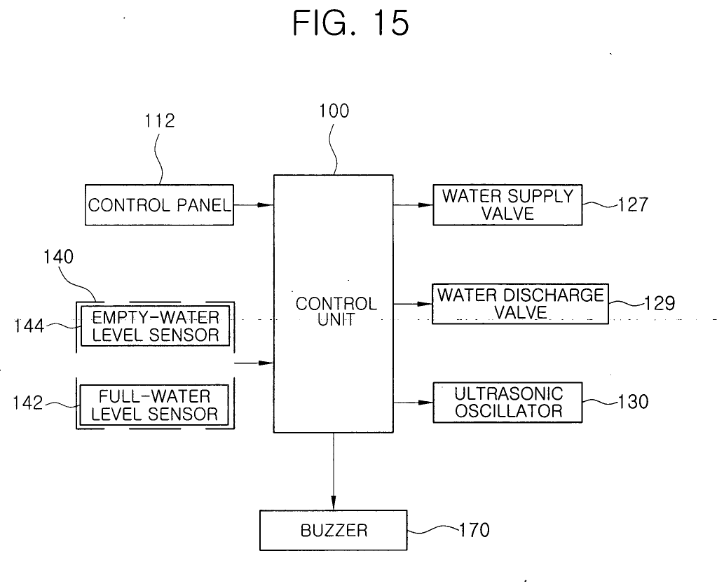

A schematic block diagram, a control flow chart view and a view showing a use status for a washer are illustrated in FIGS. 15 to 20, in order to explain an operation control method of the washer having a plurality of water level sensors according to the second embodiment of the present invention.

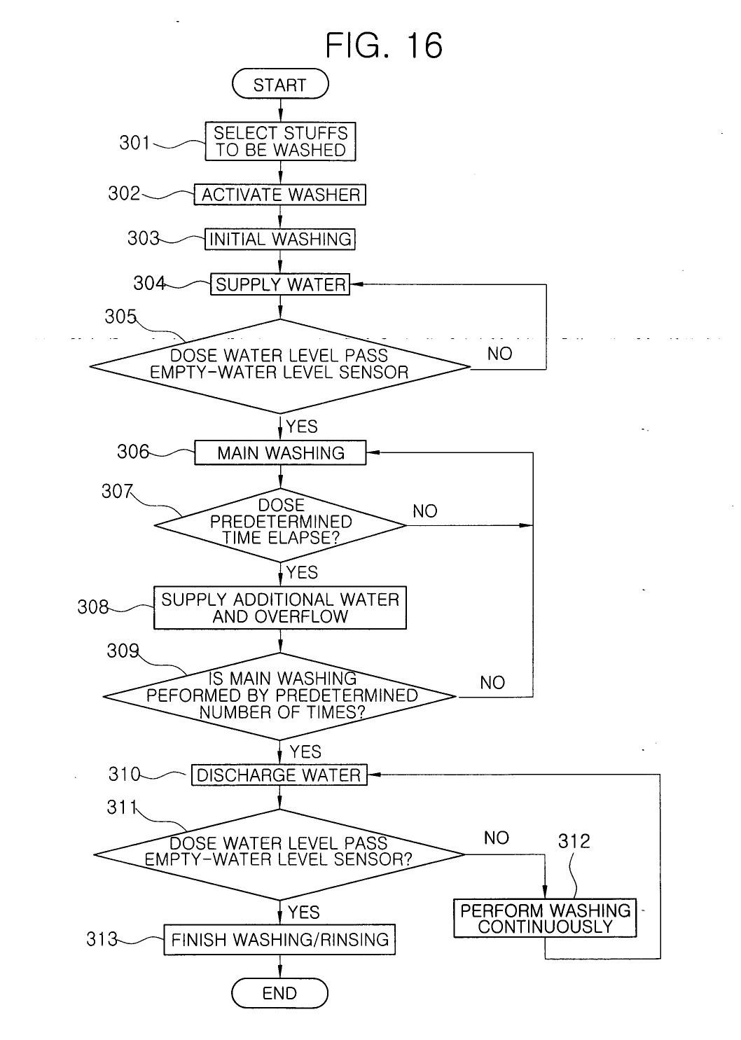

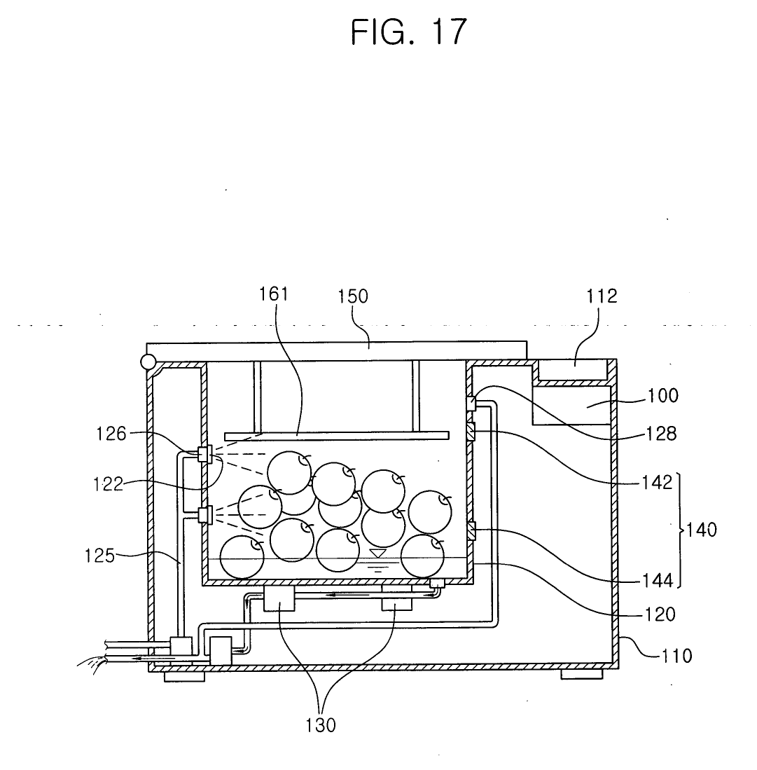

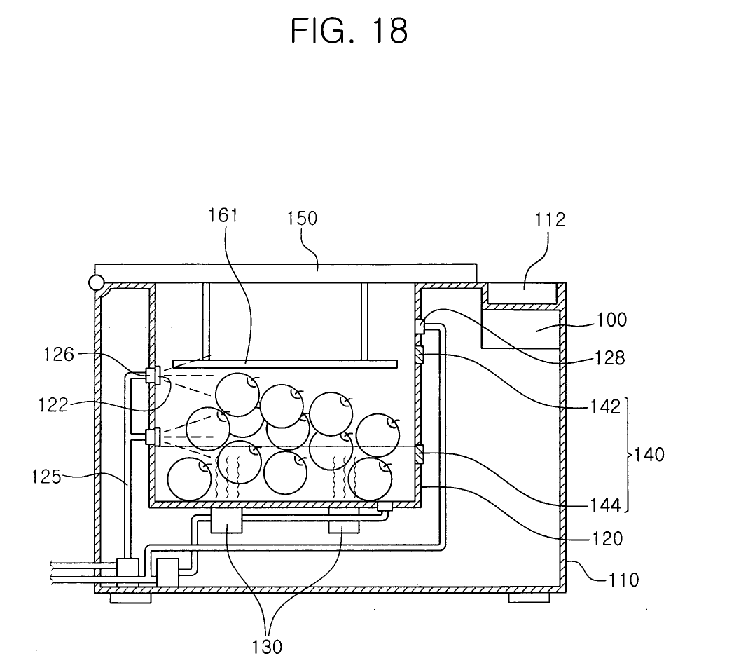

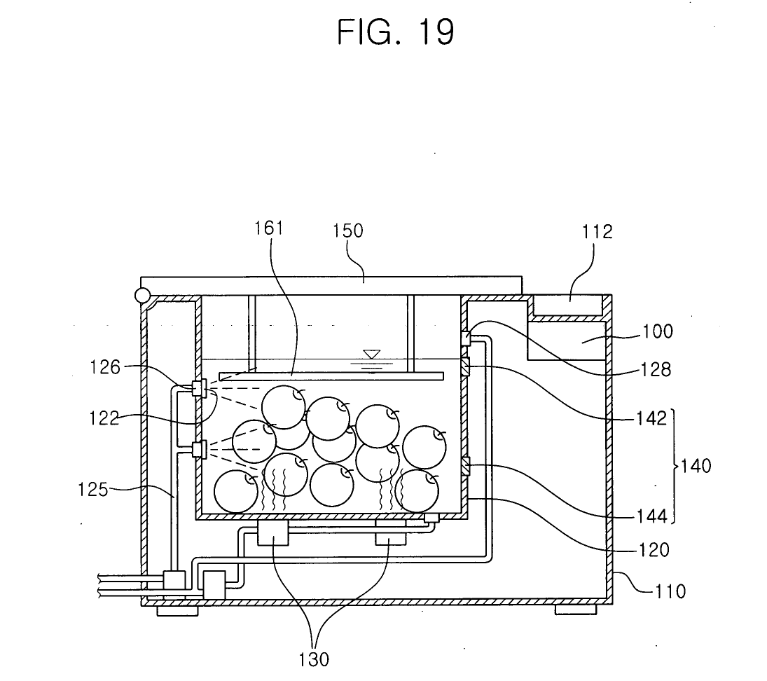

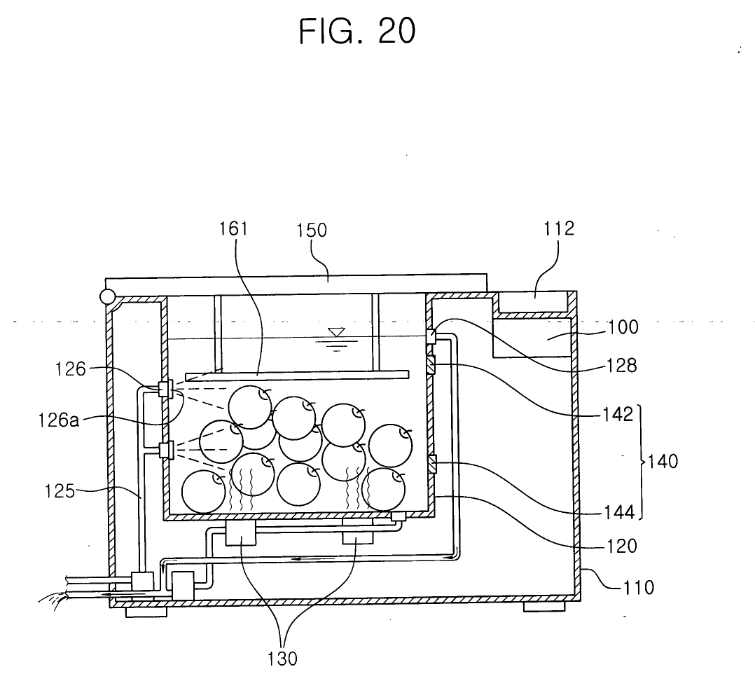

FIG. 15 is a block diagram showing correlation between some elements applied in the washer according to the second embodiment of the present invention. FIG. 16 is a flowchart view for explaining an operation control method of the washer according to the second embodiment of the present invention. FIG. 17 is a cross-sectional view showing an initial washing operation of the washer according to the second embodiment of the present invention. FIG. 18 is a cross-sectional view showing a main washing operation of the washer according to the second embodiment of the present invention. FIG. 19 is a cross-sectional view showing a main washing operation at a full-water level of the washer according to the second embodiment of the present invention. FIG. 20 is a cross-sectional view showing an overflow state of water through an additional water supply during the main washing operation of the washer according to the second embodiment of the present invention.

Here, the operation control method for a washer according to the second embodiment of the present invention is same as those for a washer according to the first embodiment of the present invention, from the step of performing an initial washing operation to the step of starting water to be supplied for a main washing operation. However, the second embodiment differs from the first embodiment in an operation start point in time and an operation stop point in time of the ultrasonic oscillator during performing a main washing operation.

Thus, the operation control method for the washer according to the second embodiment of the present invention will be described below in more detail with reference to the accompanying drawings.

As illustrated, when a user washes stuffs to be washed such as fruits and vegetables in a washer, he or she turns on the washer. Then, the user puts the stuffs in a washing chamber 120, and then closes a door 150. Then, the user selectively inputs the kind of stuffs to be washed, a water level, intensity of water supplied, and a washing time through manipulation of keys on a control panel 112 (step 301). Then, the user manipulates keys on the control panel 112 to operate the washer (step 302).

Then, the control unit 100 which receives key inputs through the control panel 112 controls the water supply valve 127 and the water discharge valve 129 so that an initial washing operation of fruits or vegetables can be performed. That is, the control unit 100 controls the water supply valve 129 to be opened to supply the washing chamber 120 with a proper amount of water.

Here, as shown in FIG. 17, water is sprayed via the shower nozzles 122 in a showering manner. That is, water of a certain water pressure is poured on stuffs to be washed for a certain time, for example, for thirty seconds, to thereby perform an initial washing operation (step 303). The control unit 100 controls the water discharge valve 129 to be opened as described above when the initial washing operation is performed, to thus discharge the foreign matters detached from the stuffs together with water via the water outlet 124 and the water discharge tube 123.

Then, as shown in FIGS. 18 and 19, the control unit 100 controls the washing chamber 120 to be filled with water for a main washing operation (step 304). That is, the control unit 100 controls the water discharge valve 129 to close the water discharge tube 123, so that water supplied to the washing chamber 120 is not discharged therefrom but stored therein.

After water starts to have been supplied into the washing chamber 120, the control unit 100 checks whether or not a water level passes an empty-water level sensor 144 (step 305). If it is determined that a water level has passed the empty-water level sensor in the result of checking of the water level in step 305, the control unit 100 controls the ultrasonic oscillator 130 to start a main washing operation via ultrasonic oscillation (step 306). As described above, the main washing operation starts together with the water supply before the water level passes over a predetermined water level, to thereby shorten an operation time of the washing process.

Here, as shown in FIG. 20, the control unit 100 controls water to be continuously supplied in the washing chamber 120 until the water level is detected by a full-water level sensor 142. Further, even though a water level reaches the full-water level, water is additionally supplied for a predetermined time, for example, about ten seconds, so that floating foreign matter can be discharged via the overflow hole 128. Accordingly, during the main washing operation called an ultrasonic washing operation, washing and sterilization is performed by a cavity phenomenon and a negative pressure effect due to the ultrasonic waves generated by the ultrasonic oscillator 130.

The, the control unit 100 checks whether a certain amount of time elapses during performing the main washing operation of step 306 (step 307). According to the result of checking in the step 307, the control unit 100 additionally supplies water every certain period of time so as to make water flow out via the overflow hole 128 (step 308). In this embodiment, water is additionally supplied for then seconds every thirty seconds after starting a washing process. Accordingly, floating light foreign matter detached from the stuffs can be discharged out together with water during performing washing. As described above, the flow-out or discharge operation of the floating matter through the additional water supply during the main washing operation prevents the floating matter from being again attached to the stuffs to be washed during discharging water after completion of the washing operation.

The control unit 100 checks whether or not the main washing operation is performed by a predetermined number of times according to the kind of the stuffs to be washed (step 309). If it is determined that the control unit 100 has not performed the main washing by the predetermined number of times according to the result of checking in step 309, the washer repeatedly performs the steps 306 through 309. If it is determined that the control unit 100 has performed the main washing by the predetermined number of times according to the result of checking in step 309, the washer controls the water discharge valve 129 through the control unit 100 to open the water supply tube 123 and discharge the water via the water outlet 124 outwards (step 310).

In particular, when the water discharge starts in the operation control method according to the second embodiment of the present invention, the checks whether or not a water level during discharging water passes the empty-water level sensor 144 (step 311). If it is determined that the water level has not passed the empty-water level sensor 144 in the result of checking in step 311, the control unit 100 continuously performs an ultrasonic operation until the water level passes the empty-water level sensor 144 (step 312). In this case, if it is determined that the water level is below the empty-water level, the ultrasonic oscillation stops. This ultrasonic washing operation during discharging water prevents the foreign matter dissolved in the water after the washing operation and the remaining floating foreign matter from being again attached to the stuffs to be washed.

Here, since a point in time of performing an ultrasonic washing operation during supplying water after having performed the initial washing operation and a point in time of stopping an ultrasonic washing operation during discharging water are based on a reference point in time due to a washing water level, the operation control method according to the second embodiment of the present invention can shorten the whole operation time relatively to that of the first embodiment of the present invention.

Then, a finish washing operation is performed through rinsing after completion of the main washing operation, to thereby have the remaining floating matter washed out again (step 313). If the washing process has been completed, the control unit 100 controls a buzzer 170 to ring to output the whole washing operation finish signal sound to inform a user of completion of the whole washing operation.

As described above, the point in time of performing the main washing operation via the ultrasonic oscillation of the ultrasonic oscillator 130 in the operation control method of the washer according to the second embodiment of the present invention is faster than that of the operation control method of the washer according to the first embodiment of the present invention. In addition, the operation control method according to the second embodiment of the present invention performs an ultrasonic washing operation until the water level during discharging water passes the empty-water level sensor 144. As a result, the operation control method according to the second embodiment of the present invention provides a less washing time and a more excellent washing effect than that of the first embodiment of the present invention.

As described above through the embodiments of the present invention, the washer sprays water through the water supply inlets 126 on the ends of which the shower nozzles 122 are formed at the state where the water outlet 124 is opened to thereby perform the initial washing operation so as to discharge foreign matter primarily.

Then, the main washing operation, that is, ultrasonic washing operation is repeatedly performed to detach foreign matters sticking to the surfaces of the stuffs to be washed through the ultrasonic oscillator 130 at the state where the stuffs are soaked in the water, to thereby enhance a washing effect.

In particular, if comparatively light foreign matters float on the water during performing the main washing operation, an additional water supply is performed at the state of a full-water level, so that the foreign matters floating on the water are discharged through the overflow hole 128. Accordingly, the floating foreign matters are prevented from being attached to the stuffs again, to thereby realize an even more excellent washing effect.

Further, in the case that the specific gravity of stuffs to be washed is light and thus the stuffs are not soaked in the water in the washing chamber 120 but floats on the water, ultrasonic oscillation of the ultrasonic oscillator 130 does not work smoothly in the water, to thereby run a risk of lowering a washing effect. In this case, as shown in the accompanying drawings, the stuffs to be washed are prevented from floating on the water in the washing chamber 120, using a pressing plate 161 which is a floating prevention unit 160 formed on the bottom of the door 150, or a washing basket 162 accommodated separately in the washing chamber 120. Accordingly, a smooth washing operation is accomplished through the ultrasonic washing operation in the water to thus enhance a washing effect.

Meanwhile, it is preferable that the water supply tube 125 is connected to an external water pipe as a water supply method of water in the above-described embodiments, to thus spray water via the water inlet 126 by a pressure of supplying water from the water pipe. However, a separate circulation pump can be provided along a water supply tube in order to spray water with a predetermined pressure.

As described above, the washer according to the present invention has been described with respect to the cases of the sensor unit having a single water level sensor, or having two water level sensors including the full-water level sensor 142 and the empty-water level sensor 144. However, it is apparent to one skilled in the art that a plurality of water level sensors are installed at interval vertically according to a capacity of the washer, to thus have a user selectively use a desired water level according to a capacity of stuffs to be washed.

In particular, only a single overflow hole 128 having water overflow at the full-water level is illustrated in the accompanying drawings. However, the present invention is not limited thereto, but includes a number of overflow holes 128 formed at interval vertically in correspondence to each of predetermined water levels so that water can overflow at a full-water level for each water level such as a high water level, medium water level and low water level which are preset according to a capacity of the washer.

Here, the overflow hole 128 can be constructed to be selectively closed or opened for each water level, by manual closing and opening operations of a user or automatic closing and opening operations of the control unit 100. Since the structure of closing and opening the above-described overflow hole 128 can be embodied sufficiently by one who has an ordinary skill in the art, description of the detailed method and structure will be omitted.

As described above, a washer according to the present invention performs an initial washing operation in which water is sprayed on the stuffs to be washed through water supply inlets formed of shower nozzles in a showering manner to remove foreign matter sticking to the stuffs to then be discharged so that foreign matter sticking to the stuffs can be primarily removed together with the water through a water outlet, and then a main washing operation in which water is filled in a washing chamber and foreign matter sticking to the stuffs is ultrasonically washed by an ultrasonic oscillator, to thus automatically and cleanly wash fruits and vegetables to be washed which requires a long washing time, and greatly enhance a washing effect.

In particular, the washer according to the present invention performs an additional water supply at the full-water level so that foreign matter floating on the water can be discharged through an overflow hole, to thus prevent the foreign matter from sticking again to the stuffs during discharging water and enhance a washing effect.

Further, in the case of the washer according to a preferred embodiment of the present invention, water level sensors are provided at predetermined water levels. Accordingly, if a water supply operation starts and a water level passes height of an empty-water level sensor, a main washing operation through ultrasonic oscillation starts. Then, an additional water supply is performed every certain period of time during performing the main washing operation, to thus have a proper amount of floating matter flow out via an overflow hole. Then, a washing process is continuously performed until a water discharge operation starts and a water level is detected by an empty-water level, to thereby shorten the whole operation time and automatically wash stuffs to be washed efficiently.

Further, in the case of the washer according to the present invention, a water discharge tube connected with a water outlet provided in a water washing chamber is formed in the form of winding the outer surface of the ultrasonic oscillator, to thereby cool heat generated from the ultrasonic oscillator and enhance durability of the ultrasonic oscillator.

Still further, a washer according to the present invention further includes a floating prevention unit which prevents floating matter from sticking again to stuffs to be washed in a washing chamber, to thereby efficiently wash stuffs to be washed having a low specific gravity and enhance a washing effect.

What is claimed is:

1. A washer comprising:
a main body forming an external case;
a washing chamber which is disposed in the main body and accommodates a stuff to be washed, including a water outlet formed on the bottom surface thereof and a water feed inlet on one end of which a shower nozzle spraying water on the surface of the stuff in a showering manner is formed;
an ultrasonic oscillator installed in one end of the washing chamber and generating vibration through ultrasonic oscillation in the washing chamber full of the washing water; and
a control unit installed in one end of the main body, which controls a washing process of the stuff.

2. The washer according to claim 1, wherein an overflow hole is formed in the upper end of the washing chamber, and through which washing water can overflow from the washing chamber.

3. The washer according to claim 1 or 2, wherein a sensor unit detecting a water level is installed in the washing chamber.

4. The washer according to claim 3, wherein the sensor unit comprises a full-water level sensor formed in the upper end of one side of the washing chamber and an empty-water level sensor formed in the lower end of one end of the washing chamber.

5. The washer according to claim 1, wherein a door is installed in one end of the main body so that an opening in the washing chamber can be closed and opened.

6. The washer according to claim 1, wherein a water discharge tube connected with the water outlet winds up around the ultrasonic oscillator so that the water discharged through the water outlet cools the ultrasonic oscillator, and extends outwards.

7. The washer according to claim 1, further comprising a floating prevention unit which prevents stuffs to be washed contained in the washing chamber from floating on the water.

8. The washer according to claim 7, wherein the floating prevention unit comprises a door installed on one end of the main body so that an opening in the washing chamber is closed and opened, and a pressing plate installed on the bottom of the door, for pressing the stuffs to be washed contained in the washing chamber.

9. The washer according to claim 7, wherein the floating prevention unit is a washing basket which comprises a basket whose upper portion is opened, containing stuffs to be washed, and a cover which can cover the opening of the basket.

10. The washer according to claim 1, wherein the water outlet and water supply inlet are automatically closed and opened by solenoid valves which are controlled by the controller.

11. The washer according to claim 2, wherein the overflow hole is installed in opposition to the water supply inlet.

12. An operation control method for a washer washing stuffs to be washed such as fruits and vegetables, the operation control method comprising the steps of:
(a) selecting the kind of the stuffs to be washed and starting a washing operation;
(b) performing an initial washing operation;
(c) performing a main washing operation, and additionally supplying water in every period of time during performing the main washing operation so that a certain amount of the water is discharged through an overflow hole; and
(d) performing a final washing operation of rinsing the stuffs when the main washing operation is finished.

13. The operation control method according to claim 12, wherein in said step (b) water is sprayed through shower nozzles in a showering manner to perform an initial washing operation of stuffs to be washed, and a water outlet is opened during performing the initial washing operation, to thereby discharge foreign matter detached from the stuffs together with the water.

14. The operation control method according to claim 12, wherein in said step (c) the main washing operation is repeatedly performed by a predetermined number of times according to the kind of the selected stuffs, and water is additionally supplied every certain period of time during performing the main washing operation, to thereby discharge the floating matter from the washing chamber at a full-water level or higher.

15. An operation control method for a washer washing stuffs to be washed such as fruits and vegetables, the operation control method comprising the steps of:
(a) selecting the kind of the stuffs to be washed and starting a washing operation;
(b) performing an initial washing operation;
(c) performing a main washing operation which supplies water until a current water level reaches a full-water level in the washing chamber detected by a full-water level sensor in the washer;
(d) additionally supplying water in every period of time during performing the main washing operation so that a certain amount of the water is discharged through an overflow hole;
(e) continuously performing a washing operation until a current water level reaches an empty-water level detected by an empty-water level sensor in the washer, during discharging the water from the washing chamber; and
(f) performing a final washing operation of rinsing the stuffs when the main washing operation is finished.

16. The operation control method according to claim 15, wherein said step (c) comprises the sub-steps of:
(3a) starting a water supply operation to fill water in the washing chamber;
(3b) checking whether or not the water level passes height of an empty-water level sensor in the washer, to then start a main washing operation through ultrasonic oscillation if the water level passes the height of the empty-water level sensor; and
(3c) checking whether or not the water level passes height of a full-water level sensor in the washer, to then continuously supply water for a predetermined time and stop the water supply, so as to discharge the floating foreign matter through the overflow hole if the water level passes the height of the full-water level sensor.

17. The operation control method according to claim 15, wherein in said step (d) the main washing operation is repeatedly performed by a predetermined number of times according to the kind of the selected stuffs, and water is additionally supplied every certain period of time during performing the main washing operation, to thereby discharge the floating matter from the washing chamber at a full-water level or higher.

18. The operation control method according to claim 15, wherein said step (f) further comprises the step of outputting a signal sound if the washing process is completed.
